(19) United States
(12) Patent Application Publication
(10) Pub. No.: US 2002/0157310 A1
(43) Pub. Date: Oct. 31, 2002

(54) Lawn moulding

(76) Inventor: Denis D. R. Rodrigue, Sherbrooke (CA)

Correspondence Address: Denis Rodrigue, 2515, Raimbault, Raimbault, Sherbrooke, QC, J1J 2J7, CA

(21) Appl. No.: 09/848,673

(22) Filed: May 4, 2001

(30) Foreign Application Priority Data
May 5, 2000 (CA) 2,306,570

(51) Int. Cl. A01G 9/02

(52) U.S. Cl. 47/66.6

(57) ABSTRACT

A decorative utility item consisting of a lawn molding that can be installed around a house or other building, designed to eliminate the growth of grass around the building while adding a decorative touch. This molding is characterized by two perpendicular parts with a combination of two different angles, making the molding more waterproof The molding is also characterized by three braces behind a curved part, and a hook system to attach the molding on a long-term basis, thus eliminating the need for anchoring by screws, nails, or other objects of that type.

The invention comprises a lawn moulding that can be installed around a house or other building. It is well known that people are increasingly concerned with landscape improvements and maintenance. This invention eliminates the growth of grass around a house or other building, while adding a touch of beauty to the landscape.

Eliminating grass around a house or other building presently involves the use of many items such as grass trimmers, long-handle grass scissors, extension cords, and safety goggles. This lawn moulding makes landscaping simple and safe by eliminating the need for these items.

The invention comprises a lawn moulding that can be installed around a house or other building by inserting the lower portion of the said moulding into the ground along the foundation so that the outer parts of the moulding are held in place, covering a portion of both the foundation and the lawn. Adequate adherence of the outer parts is ensured by a curved part that connects them together. The braces behind the curve hold it in place and absorb any shocks to which it may be subjected. The underground part of the moulding has built-in hooks and thus requires no anchoring, no screws, nails, or other fasteners.

The following drawings illustrate the invention:

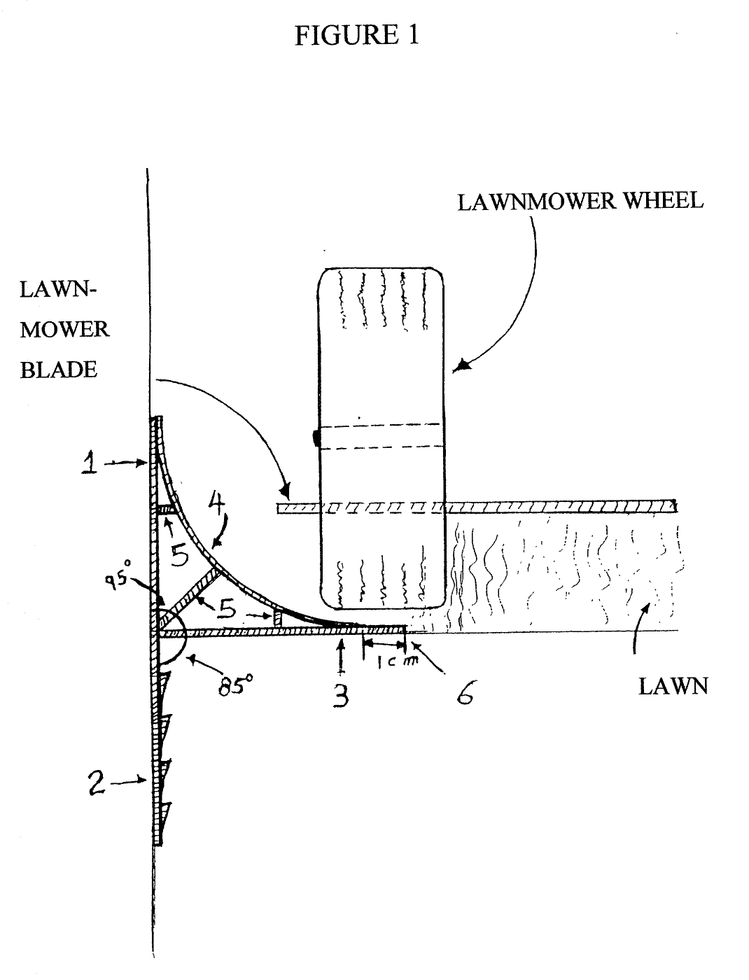

FIG. 1 is a cross-section view of the invention.

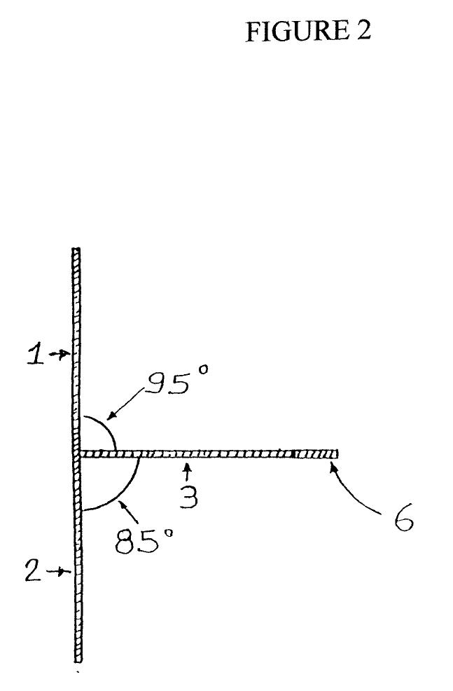

FIG. 2 is a cross-section view showing only the angles.

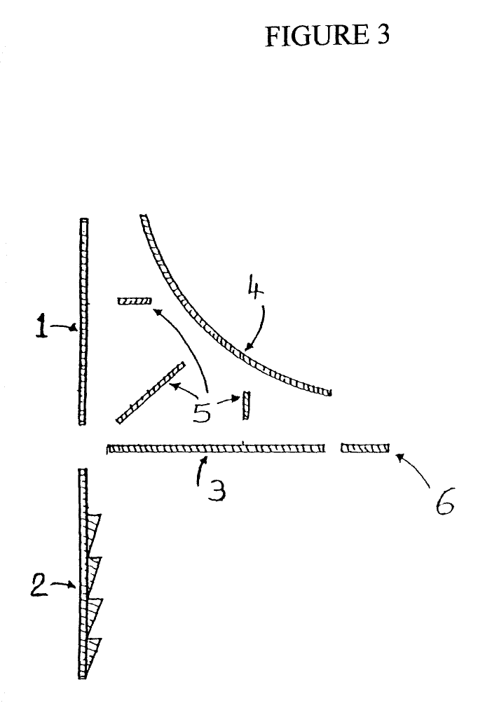

FIG. 3 is an exploded sectional view of the invention.

In a preferred embodiment (see FIG. 1), in order to prevent the accumulation of grass and other debris beneath item 1, the moulding is forced against the foundation by the 85° angle that exists between items 2 and 3. When the moulding is inserted into the ground, items 2 and 3 tend to hug the ground and the foundation (theoretically, they form a 90° angle). The pressure thus generated forces item 1 against the foundation.

In another preferred embodiment, item 2 of the said moulding shows inverted triangular hooks; these hooks keep the moulding from leaving its initial position, eliminating the need for any type of anchoring.

In another preferred embodiment, item 6 of the moulding is not under the curved part, and forms a flat surface. This provides more leeway for the wheels of a lawnmower and makes it possible to cut the grass as close as possible to the moulding without damaging it.

In a preferred embodiment, item 4 provides additional space, allowing the blade to cut lower without damage. In the event of rain, the curve produces a self-cleaning effect, so that debris and other deposits are automatically carried away.

In a preferred embodiment, item 5 is made up of three braces, two of them located three centimeters from the junction of items 1 and 3 and the third located at the centerpoint of item 4. The braces hold the curved part in place and reinforce it against external pressures.

The embodiments for which an exclusive right of property or privilege is claimed are defined as follows:

1. A utility lawn moulding that is also decorative, characterized by a curved part that allows the lawnmower blade to cut more closely, with a flat section extending from 0.5 to 3 centimeters beyond the end of the curved portion, allowing the lawnmower blade to cut still more closely. The purpose of the moulding curve is not only to allow grass to be cut closer to the building, but also to prevent the lawnmower blade from damaging the moulding. A right of property is thus claimed for: the two different angles making up the horizontal portion of the moulding, making the outer vertical portion of the moulding more waterproof; the hook system which allows for easy, low-cost anchoring; the three braces that hold the curved portion in place and protect it against any pressures to which it may be subjected.

2. A lawn moulding in accordance with claim 1, wherein the said curved portion allows a close cut and avoids damage to the moulding.

3. A lawn moulding in accordance with claim 2, wherein the flat extension of the said curved portion shall be from 0.5 to 3.0 centimeters long.

4. A lawn moulding in accordance with claim 2, wherein three braces hold the said curved portion in place and reinforce it against external pressures resulting from lawnmower wheels, walking, or other causes.

5. A lawn moulding in accordance with claim 1, wherein the 180° is divided between the different angles forming the horizontal and vertical parts as follows: 90° or more for the outer part, 90° or less for the underground part.

6. A lawn moulding in accordance with claim 1, wherein the underground part comprises built-in inverted triangular hooks, which allow it to be effectively held in the ground on a long-term basis without requiring the use of nails, screws, or other such fasteners.
